(19) United States
(12) Patent Application Publication
(10) Pub. No.: US 2020/0005151 A1
(43) Pub. Date: Jan. 2, 2020

(54) ARTIFICIAL NEURAL NETWORK

(71) Applicant: Nokia Technologies Oy, Espoo (FI)

(72) Inventor: Xiaoheng JIANG, Tianjin (CN)

(21) Appl. No.: 16/473,489

(22) PCT Filed: Dec. 30, 2016
(86) PCT No.: PCT/CN2016/113477

§ 371 Date: Jun. 25, 2019

(51) Int. Cl. G06N 3/08; G06N 3/04; G06K 9/62; G06F 17/15

(52) U.S. Cl. CPC G06N 3/084; G06F 17/15; G06K 9/6267; G06N 3/04

(57) ABSTRACT

According to an example aspect of the present invention, there is provided a method, comprising: resizing a convolutional layer input of an artificial neural network with at least two different scales to obtain multiple groups of intermediate features maps, convolving the intermediate feature maps with a filter, resizing the convolution results to the size of the layer input, and concatenating the resized convolution results to form an output of the convolutional layer.

### FIELD

The present invention relates to artificial neural networks, and further to convolutional artificial neural networks.

### BACKGROUND

Machine learning and machine recognition finds several applications, such as image recognition, object detection and acoustic recognition. For example, neural networks may be applied for automated passport control at airports, where a digital image of a person's face may be compared to biometric information, stored in a passport, characterizing the person's face.

Another example of machine recognition is in handwriting or printed document text recognition, to render contents of books searchable, for example. A yet further example is pedestrian recognition, wherein, ultimately, a self-driving car is thereby seen as being enabled to become aware a pedestrian is ahead and the car can avoid running over the pedestrian.

In addition to visual recognition, spoken language may be the subject of machine recognition. When spoken language is recognized, it may be subsequently input to a parser to provide commands to a digital personal assistant, or it may be provided to a machine translation program to thereby obtain a text in another language, corresponding in meaning to the spoken language.

Machine recognition technologies employ algorithms engineered for this purpose. For example, artificial neural networks may be used to implement machine vision applications. Artificial neural network may be referred to herein simply as neural networks. Machine recognition algorithms may comprise processing functions, in recognition of images such processing functions may include, for example, filtering, such as morphological filtering, thresholding, edge detection, pattern recognition and object dimension measurement.

Artificial neural networks are computational tools capable of machine learning. In artificial neural networks, which may be referred to as neural networks hereinafter, interconnected computation units known as neurons are allowed to adapt to training data, and subsequently work together to produce predictions in a model that to some extent may resemble processing in biological neural networks.

Neural networks may comprise a set of layers, the first one being an input layer configured to receive an input. The input layer comprises neurons that are connected to neurons comprised in a second layer, which may be referred to as a hidden layer. Neurons of the hidden layer may be connected to a further hidden layer, or an output layer.

A neural network may be comprise, for example, fully connected layers and convolutional layers. A fully connected layer may comprise a layer wherein all neurons have connections to all neurons on an adjacent layer, such as, for example, a previous layer. A convolutional layer may comprise a layer wherein neurons receive input from a part of a previous layer, such part being referred to as a receptive field, for example. Some neural networks comprise both fully connected layers and layers that are not fully connected. Convolutional neural networks, CNN, are feed-forward neural networks that comprise layers that are not fully connected. In CNNs, neurons in a convolutional layer are connected to neurons in a subset, or neighbourhood, of an earlier layer. This enables, in at least some CNNs, retaining spatial features in the input. CNNs may have both convolutional and fully connected layers. Fully connected layers in a CNN may be referred to as densely connected layers. There is generally a need to improve computational efficiency of CNNs.

### SUMMARY OF THE INVENTION

The invention is defined by the features of the independent claims. Some specific embodiments are defined in the dependent claims.

According to a first aspect of the present invention, there is provided a method, comprising: resizing a convolutional layer input of an artificial neural network with at least two different scales to obtain multiple groups of intermediate features maps, convolving the intermediate feature maps with a filter, resizing the convolution results to the size of the layer input, and concatenating the resized convolution results to form an output of the convolutional layer.

Various embodiments of the first aspect may comprise at least one feature from the following bulleted list:
the layer is a layer pyramid comprising the multiple groups of intermediate feature maps of different scales, a series of layer pyramids is cascaded, and a classification decision is prepared upon result of the last pyramid layer in the series.
the intermediate feature maps are convolved with a single size filter.
downsampling the output of the convolution layer to form a subsequent convolutional layer input, and constructing the subsequent convolutional layer starting from the downsampled output.
receiving a set of training data, selecting a number of multi-scale convolutional layers, defining the different scales, forming each multi-scale convolutional layer by convolving the multiple groups of intermediate features maps at different scales and concatenating the resized convolution results, constructing the deep convolutional neural network by cascading a series of the layers, and training the filters in each layer pyramid by applying a backpropagation method.
the constructed and trained neural network is tested by computing the series of convolutional layers for a test image and making a classification decision upon result of the last convolutional layer in the series.
different weights are applied for convolution at different scales.

According to a second aspect of the present invention, there is provided an apparatus comprising memory configured to store data defining, at least partly, an artificial neural network, and at least one processing core configured to extract a convolutional layer of the artificial neural network by applying a filter for convolving a layer input at at least two different scales and concatenating resized convolution results.

According to a third aspect of the present invention, there is provided an apparatus comprising means for resizing a convolutional layer input of an artificial neural network with at least two different scales to obtain multiple groups of intermediate features maps, means for convolving the intermediate feature maps with a filter, means for resizing the convolution results to the size of the layer input, and means for concatenating the resized convolution results to form an output of the convolutional layer.

According to a fourth aspect of the present invention, there is provided a non-transitory computer readable medium having stored thereon a set of computer readable instructions that, when executed by at least one processor, cause an apparatus to at least resize a convolutional layer input of an artificial neural network with at least two different scales to obtain multiple groups of intermediate features maps, convolve the intermediate feature maps with a filter, resize the convolution results to the size of the layer input, and concatenate the resized convolution results to form an output of the convolutional layer.

According to a fifth aspect of the present invention, there is provided a computer program configured to cause a method in accordance with the first aspect to be performed.

### BRIEF DESCRIPTION OF THE DRAWINGS

FIG. 1 illustrates an example system capable of supporting at least some embodiments of the present invention;

FIG. 2a illustrates extraction of a convolutional layer in accordance with at least some embodiments of the present invention;

FIG. 2b illustrates composition of a deep neural network in accordance with at least some embodiments of the present invention;

FIG. 3 illustrates an example apparatus capable of supporting at least some embodiments of the present invention;

FIG. 4 illustrates a neural network in accordance with at least some embodiments of the present invention, and

FIG. 5 is a flow graph of a method in accordance with at least some embodiments of the present invention.

### EMBODIMENTS

Computational cost can be reduced by extracting a convolutional layer by applying a filter for convolving a layer input at multiple different scales and concatenating convoluted feature maps resized to the input size. Such multi-scale layers may be referred to as pyramid layers or layer pyramids. When compared to convolution with multi-scale filters, generation of such pyramid layer with a single-size small filter, such as a 3×3 filter, consumes much less computation while reaching the goal of multi-scale feature extraction, such as appropriate pattern recognition accuracy.

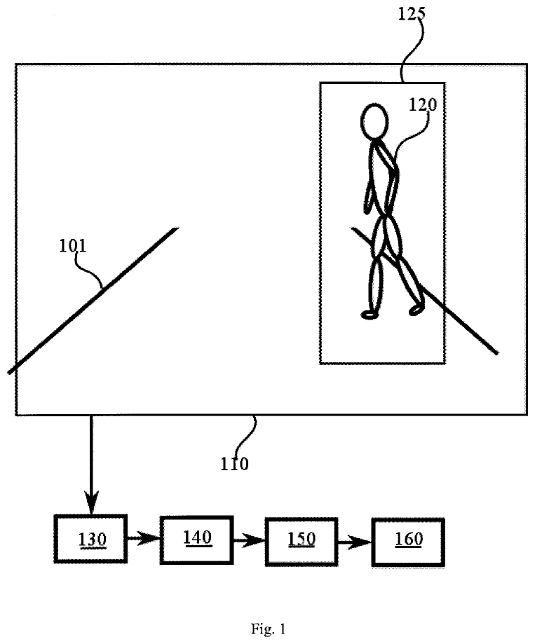

FIG. 1 illustrates an example system capable of supporting at least some embodiments of the present invention. FIG. 1 has a view 110 of a road 101, on which a pedestrian 120 is walking. While described herein in connection with FIG. 1 in terms of detecting pedestrians, the invention is not restricted thereto, but as the skilled person will understand, the invention is applicable also more generally to machine recognition in visual, audio or other kind of data. For example, bicyclist recognition, handwriting recognition, facial recognition, large-scale image classification, traffic sign recognition, voice recognition, language recognition, sign language recognition, game applications, and/or spam email recognition may benefit from the present invention, depending on the embodiment in question. Particular advantage may be achieved with highly time-critical applications, such as applications of self-driving cars or driver assistance systems.

In FIG. 1, road 101 is imaged by a camera. The camera may be configured to capture a view 110 that covers the road, at least in part. The camera may be configured to pre-process image data obtained from an image capture device, such as a charge-coupled device, CCD, comprised in the camera. Examples of pre-processing include reduction to black and white, contrast adjustment and/or brightness balancing to increase a dynamic range present in the captured image. In some embodiments, the image data is also scaled to a bit depth suitable for feeding into an image recognition algorithm, such as AdaBoost, for example. Pre-processing may include selection of an area of interest, such as area 125, for example, for feeding into the image recognition algorithm. Pre-processing may be absent or limited in nature, depending on the embodiment. The camera may be installed, for example, in a car that is configured to drive itself, or collect training data. Alternatively, the camera may be installed in a car designed to be driven by a human driver, but to provide a warning and/or automatic braking if the car appears to be about to hit a pedestrian or an animal.

An image feed from the camera may be used to generate a test dataset for use in training a neural network. Such a dataset may comprise training samples. A training sample may comprise a still image, such as a video image frame, or a short video clip, for example. Where the incoming data to be recognized is not visual data, the incoming data may comprise, for example, a vector of digital samples obtained from an analogue-to-digital converter. The analogue-to-digital converter may obtain an analogue feed from a microphone, for example, and generate the samples from the analogue feed. Overall, as discussed above, data of non-visual forms may also be the subject of machine recognition. For example, accelerometer or rotation sensor data may be used to detect whether a person is walking, running or falling. As a neural network may be trained to recognize objects in view 110, a training phase may precede a use phase, or test phase, of the neural network.

Data is provided from camera 130 to a convolutional neural network, which comprises phases 140, 150, and 160. Phase 140 comprises a first convolutional layer, which is configured to process the image received from camera 130. The first convolutional layer 140 may comprise a plurality of filters arranged to process data from the image received from camera 130. A section of the image provided to a filter may be referred to as the layer input or the receptive field of the filter. An alternative term for a filter is a kernel. Receptive fields of neighbouring filters may overlap to a degree, which may enable the convolutional neural network to respond to objects that move in the image, for example.

The first convolutional layer 140 may produce a plurality of feature maps. A second convolutional layer 150 may receive these feature maps, or be enabled to read these feature maps from the first convolutional layer 140. The second convolutional layer 150 may use all feature maps of first convolutional layer 140 or only a subset of them. A subset in this regard means a set that comprises at least one, but not all, of the feature maps produced by first convolutional layer 140. The second convolutional layer 150 may be configured to process feature maps produced in the first convolutional layer, using a filter of the second convolutional layer 150, to produce second-layer feature maps. The second-layer feature maps may be provided, at least in part, to a third convolutional layer 160 which may, in turn, be arranged to process the second-layer feature maps using a filter or filters of the third convolutional layer 160, to produce at least one third-layer feature map as the output.

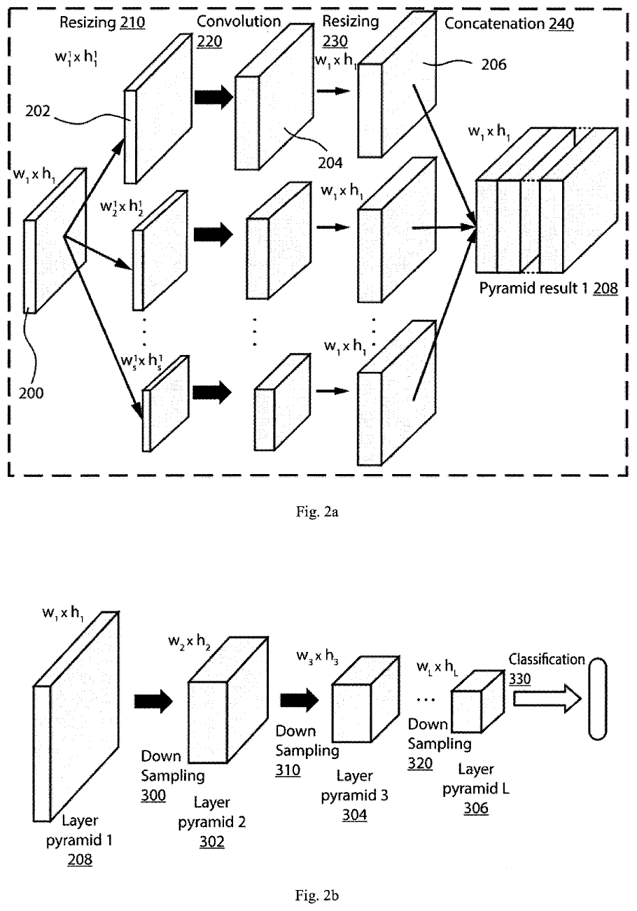

FIG. 2a illustrates generation of a multi-scale convolutional layer for a deep neural network in accordance with at least some embodiments of the present invention. The spatial size of the input of the layer 200 is w₁×h₁, for example 32×32. The input layer is first resized 210 with S different scales, such as 3 different scales. This results in S groups of intermediate feature maps 202 with different resolutions, for example 32×32, 24×24, and 16×16). Then filters of one small and fixed size, such as 3×3, may be used to convolve 220 with the S groups of intermediate feature maps 204, respectively. These obtained intermediate feature maps 204 are first resized 230 to the same size of the input layer 200 and then concatenated 240 to form the final pyramid result and the output (of the) convolutional layer 208. Hence, information of all applied scales may be concatenated at each spatial location, which facilitates boosting the representation ability of deep CNNs.

A multi-scale convolutional layer extracted as illustrated in connection with FIG. 2a may be referred to as a layer pyramid, comprising the convoluted multiple groups of intermediate feature maps of different scales. The deep CNN may be computed by cascading a series of such layer pyramids, such CNN structure may also be referred to as a pyramid structure. A classification decision is prepared upon result of the last pyramid layer in the series.

FIG. 2b illustrates composition of a deep neural network by cascading a series of layer pyramids in accordance with at least some embodiments of the present invention. By properly resizing, filtering and concatenating, as illustrated in FIG. 2a, the pyramid result of the first layer pyramid 208 is computed. The result of first layer pyramid 208 is downsampled 300 and used as the input for forming the second, subsequent layer pyramid. A Max pooling procedure may be applied for advancing from layer to layer. The pyramid result 302 can be again obtained with proper resizing, filtering and concatenating. Analogically, the pyramid results 304, 306 of the following layer pyramids can be downsampled 310, 320 and computed. Finally, a classification decision is made 330 upon the last pyramid layer L 306.

During a training stage, the steps illustrated above in connection with FIGS. 2a and 2b may be applied to construct the structure of the layer pyramid based deep CNN and to learn the parameters of the constructed deep CNN. The testing stage may involve:

Step 1: Prepare a set of training images and their labels.

Step 2: Design the number L of convolutional layers of the deep CNN. Set the number s of the different scales. Let wᵢ×hᵢ be the size of the feature map in layer i.

Step 3: Use a layer pyramid to form each convolutional layer and construct the deep CNN by cascading a series of the layer pyramids.

Step 4: Employ a backpropagation method to train the parameters of the small filters in each layer pyramid.

With the structure and parameters of the trained deep CNN, the CNN may be tested to classify an unknown testing image by applying the features illustrated above in connection with FIGS. 2a and 2b. Thus, the testing image is taken as the input of the layer pyramid based deep CNN and L number of pyramid layers may be computed, resulting in classification.

The filters of the multi-scale convolutional layer 200 may employ the same weights, meaning that while weights may differ between neurons comprised in a filter, filter weight tables are the same for each filter of first convolutional layer 140. This reduces the number of independent weights and causes the convolutional neural network to process different sections of the image in a similar way. In, for example, pedestrian detection, this may be useful since a pedestrian may be present in any part of the image. Controlling the number of independent weights may also provide the advantage that training the convolutional neural network is easier. In some embodiments, different weights are applied to convolve the input at different scales. This enables to capture richer information than by using same weights.

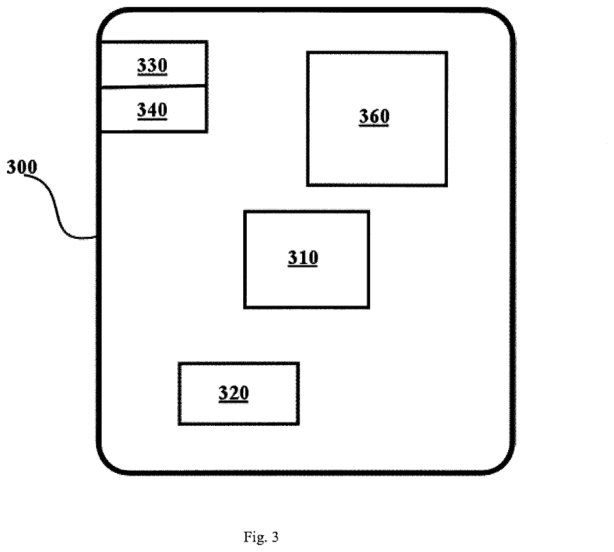

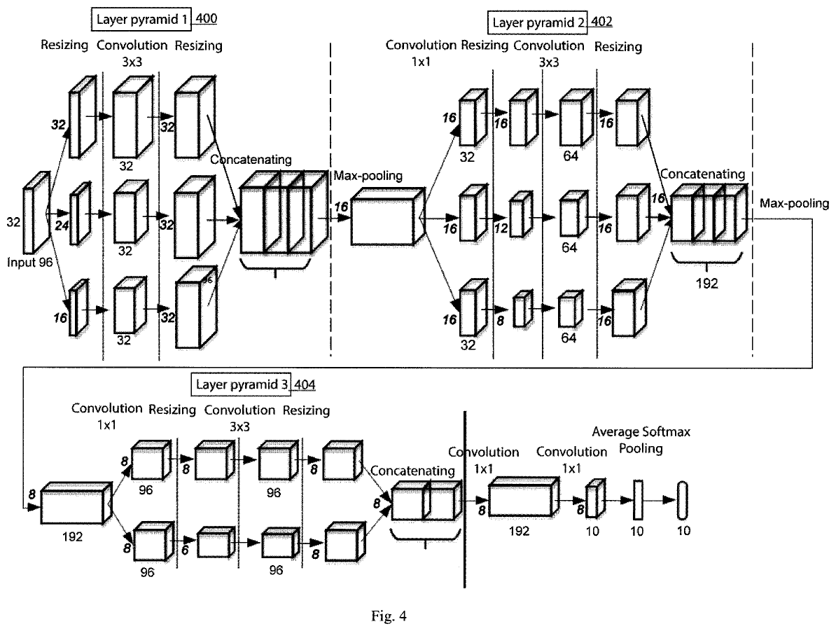

FIG. 3 illustrates an example apparatus capable of supporting at least some embodiments of the present invention. Illustrated is device 300, which may comprise, for example, computing device such a server, node or cloud computing device. Device 300 may be configured to run a neural network, such as is described herein. Comprised in device 300 is processor 310, which may comprise, for example, a single- or multi-core processor wherein a single-core processor comprises one processing core and a multi-core processor comprises more than one processing core. Processor 310 may comprise more than one processor. A processing core may comprise, for example, a Cortex-A8 processing core by ARM Holdings or a Steamroller processing core produced by Advanced Micro Devices Corporation. Processor 310 may comprise at least one Qualcomm Snapdragon and/or Intel Core processor, for example. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions, such as to cause at least some of the features regarding composing and running of a deep CNN as illustrated in connection with FIGS. 2a, 2b, 4, and/or 5.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Computer instructions in memory 320 may comprise a plurality of applications or processes. For example, machine learning algorithms, such as an AdaBoost algorithm with its classifiers, may run in one application or process, a camera functionality may run in another application or process, and an output of a machine learning procedure may be provided to a further application or process, which may comprise an automobile driving process, for example, to cause a braking action to be triggered responsive to recognition of a pedestrian in a camera view.

Device 300 may comprise a transmitter 330. Device 300 may comprise a receiver 340. Transmitter 330 and receiver 340 may be configured to transmit and receive, respectively, information in accordance with at least one communication standard. Transmitter 330 may comprise more than one transmitter. Receiver 340 may comprise more than one receiver. Transmitter 330 and/or receiver 340 may be configured to operate in accordance with wireless local area network, WLAN, Ethernet, universal serial bus, USB, and/or worldwide interoperability for microwave access, WiMAX, standards, for example. Alternatively or additionally, a proprietary communication framework may be utilized.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure machine learning parameters and/or to switch device 300 on and/or off.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above.

Processor 310, memory 320, transmitter 330, receiver 340, and/or UI 360 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

The performance of a pyramid CNN structure according to presently disclosed embodiments with pyramid layers has been compared to a reference CNN structure on CIFAR-10 dataset. The pyramid CNN structure is illustrated in FIG. 4.

The pyramid CNN structure has three layer pyramids 400, 402, and 404. The digits bolded on left side of the feature maps represent their sizes. For example, in first layer pyramid 400, the sizes of input intermediate feature maps are 32, 24 and 16, respectively. The digits below the feature maps represent the number of feature maps. The second layer pyramid 402 also has three scales, with sizes of 16, 12 and 8, respectively. The third layer pyramid 404 has two scales, with sizes of 8 and 6, respectively. The layer pyramids are generated as illustrated above in connection with FIGS. 2a and 2b. A 3×3 filter is used for convolution and processing advances from layer to layer via a Max pooling procedure.

The reference structure in the present experiment is similar to the structure of FIG. 4, except that it has one single input scale and adopts filters of multiple scales. In the reference CNN structure, the first block, corresponding to the first layer pyramid 400, has three kinds of filters, with sizes of 3×3, 5×5 and 7×7. The second block of the reference structure has the same size of filters as the first block. The third block has two kinds of filters, with sizes of 3×3 and 5×5. Both the present pyramid CNN structure and the reference CNN structure have the same number of feature maps.

The experimental results are shown in Table 1. These results are obtained under GPU mode. It is seen pyramid CNN structure according to presently disclosed embodiments consumes much fewer parameters and processes images much faster than the reference CNN structure, while achieving almost the same test error. This demonstrates that the presently disclosed structure can substantially improve computational efficiency.

TABLE 1
Comparison of performance

| | | | Parameters | Testing Speed |
|---|---|---|---|---|
| Dataset | Approach | Test Error | (in million) | (images/second) |
| CIFAR-10 | Reference | 8.21% | 0.576 | 560 |
| | CNN | | | |
| | Pyramid | 8.26% | 0.308 | 912 |
| | CNN | | | |

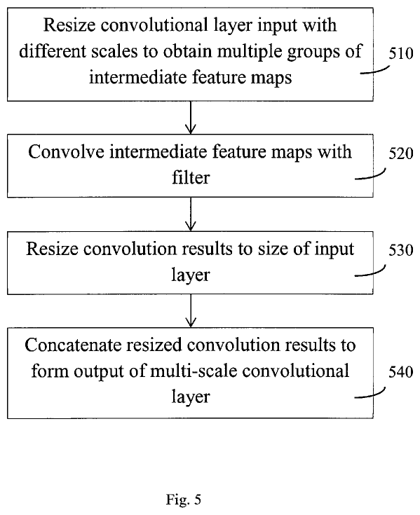

FIG. 5 is a flow graph of a method for forming or running a multi-scale convolutional layer in accordance with at least some embodiments of the present invention. The phases of the illustrated method may be performed in a device arranged to run the neural network, for example, by a control device of such a device. The method may be applied with various embodiments illustrated and envisaged above.

A convolutional layer input of a deep artificial neural network is obtained or received by an entity running the method. The layer input may be the dataset to be processed, such an input image, or a output of preceding convolutional layer. The layer input is resized 510 with at least two different scales to obtain multiple groups of intermediate features maps (of different sizes). The intermediate feature maps are convolved 520 with a filter. The convolution results are resized 530 to the size of the layer input. The resized convolution results are concatenated 540 to form an output of the convolutional layer.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in optimizing machine recognition, to, for example, reduce traffic accidents in self-driving vehicles.

### ACRONYMS

| | |
|---|---|
| CDD | charge-coupled device |
| CNN | convolutional neural network |
| GPU | graphics processing unit |

### REFERENCE SIGNS LIST

| | |
|---|---|
| 110 | View |
| 101 | Road |
| 125 | Area of interest |
| 120 | Pedestrian |
| 130 | First layer |
| 140 | Second layer |
| 150 | Third layer |
| 200-208 | Feature maps of FIG. 2a |
| 201-240 | Processing operations of FIG. 2b |
| 208-306 | Feature maps of FIG. 2a |
| 300-330 | Processing operations of FIG. 2b |
| 300-360 | Structure of device of FIG. 3 |
| 400-404 | Layer pyramids of the neural network illustrated in FIG. 4 |
| 510-540 | Phases of the method of FIG. 5 |

1-19. (canceled)

20. A method, comprising:
resizing a convolutional layer input of a convolutional artificial neural network with at least two different scales to obtain multiple groups of intermediate features maps,
convolving the intermediate feature maps with a filter,
resizing the convolution results to the size of the layer input, and
concatenating the resized convolution results to form an output of the convolutional layer.

21. The method of claim 20, wherein the layer is a layer pyramid comprising the multiple groups of intermediate feature maps of different scales,
a series of layer pyramids is cascaded, and
a classification decision is prepared upon result of the last pyramid layer in the series.

22. The method of claim 20, wherein the intermediate feature maps are convolved with a single size filter.

23. The method of claim 20, wherein the convolutional artificial neural network is constructed and trained by:
receiving a set of training data,
selecting a number of multi-scale convolutional layers,
defining the different scales,
forming each multi-scale convolutional layer by convolving the multiple groups of intermediate features maps at different scales and concatenating the resized convolution results,
constructing the convolutional artificial neural network by cascading a series of the layers, and
training the filters in each layer pyramid by applying a backpropagation method.

24. The method of claim 23, wherein the constructed and trained neural network is tested by computing the series of convolutional layers for a test image and making a classification decision upon result of the last convolutional layer in the series.

25. The method of claim 20, wherein different weights are applied for the convolution at different scales.

26. The method of claim 20, further comprising: downsampling the output of the convolution layer to form a subsequent convolutional layer input, and constructing the subsequent convolutional layer starting from the downsampled output.

27. An apparatus comprising:
memory configured to store data defining, at least partly, a convolutional artificial neural network, and
at least one processing core configured to extract a convolutional layer of the convolutional artificial neural network by applying a filter for convolving a layer input at at least two different scales and concatenating resized convolution results.

28. The apparatus of claim 27, wherein the processing core is configured to resize the layer input of the convolutional artificial neural network with the at least two different scales to obtain multiple groups of intermediate features maps, convolve the intermediate feature maps with the filter, and resize the convolution results to the size of the layer input.

29. The apparatus of claim 27, wherein the layer is a layer pyramid comprising the multiple groups of intermediate feature maps of different scales, and the processing core is configured to cascade a series of layer pyramids and prepare a classification decision upon result of the last pyramid layer in the series.

30. The apparatus of claim 27, wherein the filter is of a single size.

31. The apparatus of claim 27, wherein the processing core is configured to construct and train the convolutional artificial neural network by:
receiving a set of training data,
selecting a number of multi-scale convolutional layers,
defining the different scales,
forming each multi-scale convolutional layer by convolving the multiple groups of intermediate features maps at different scales and concatenating the resized convolution results,
constructing the convolutional artificial neural network by cascading a series of the layers, and
training the filters in each layer pyramid by applying a backpropagation method.

32. The apparatus of claim 31, wherein the processing core is configured to test the constructed and trained neural network by computing the series of convolutional layers for a test image and making a classification decision upon result of the last convolutional layer in the series.

33. The apparatus of claim 27, wherein the processing core is configured to apply different weights for the convolution at different scales.

34. The apparatus of claim 27, wherein the processing core is configured to downsample the output of the convolution layer to form a subsequent convolutional layer input, and construct the subsequent convolutional layer starting from the downsampled output.

35. A non-transitory computer readable medium having stored thereon a set of computer readable instructions that, when executed by at least one processor, cause an apparatus to at least:
resize a convolutional layer input of a convolutional artificial neural network with at least two different scales to obtain multiple groups of intermediate features maps,
convolve the intermediate feature maps with a filter,
resize the convolution results to the size of the layer input, and
concatenate the resized convolution results to form an output of the convolutional layer.
